(19) United States
(12) Patent Application Publication
(10) Pub. No.: US 2008/0084614 A1
(43) Pub. Date: Apr. 10, 2008

(54) Reflective Electrowetting Lens

(75) Inventor: Christoph Dobrusskin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (DE)

(21) Appl. No.: 11/574,737

(22) PCT Filed: Sep. 8, 2005
(86) PCT No.: PCT/IB05/52921

§ 371 Date: Mar. 6, 2007

(30) Foreign Application Priority Data
Sep. 9, 2004 (EP) 04104358.9

(51) Int. Cl. G02B 3/12

(52) U.S. Cl. 359/665

(57) ABSTRACT

The present invention provides a reflective electrowetting device (200) comprising a fluid chamber that contains two immiscible fluids (205, 206) that are separated by a meniscus (208); the fluid chamber further comprises electrodes(203, 204), and a wetting surface (207) that has different wetting properties in respect of the two immiscible fluids (205, 206); electrowetting forces, provided by the interaction of lyophobic and electrostatic forces, are utilized to control the meniscus (208) such that light (210, 212) impinging the meniscus is reflected by total reflection at the meniscus; the present inventions furthermore provides a system and an array of such reflective electrowetting devices.

### FIELD OF THE INVENTION

The present invention relates to reflective light valves.

### TECHNICAL BACKGROUND

Reflective light valves are used in many different applications for manipulating and controlling the direction of light waves. Examples of such applications include projection systems, projection displays, and illumination systems.

The most common type of reflective light valve is constituted by a rotating mirror that reflects incoming light waves in a desired direction depending on the angular position of the mirror. Such arrangements are well known, and are currently used in different configuration. One example of a rotating mirror configuration is given in U.S. Pat. No. 4,934,781. However, such arrangements obviously include moving parts that are subject to significant wear resulting in deteriorated performance over time. Additional disadvantages using rotating mirrors include noise and vibrations.

Hence, there is a need for improved reflective light valves.

### SUMMARY OF THE INVENTION

The object of the present invention is thus to provide improved reflective light valves that alleviate the above problems.

This object is fulfilled by a reflective light valve in the form of a reflective electrowetting device as defined in appended claim 1, by a reflective system as defined in claim 7, and by an array as defined in claim 8. Advantageous embodiments of the invention are defined in the appended sub claims. The present invention also provides a way of using a reflective electrowetting device.

Hence, according to one aspect of the present invention, a reflective electrowetting device is provided. The reflective electrowetting device defines a light path for light waves and comprises a fluid chamber, at least two electrodes, a wetting surface, and an electrowetting fluid system contained in said fluid chamber and comprising a front fluid and a backside fluid. The front fluid and backside fluid have different electrical properties, different wetting properties in respect of the wetting surface, and are separated by a meniscus that has a shape that is controllable by an electric field applied across the electrodes. The front fluid forms part of the light path and has an index of refraction that is higher than that of the backside fluid such that total reflection is provided in the light path by the meniscus at an angle of reflectance that depends on the shape of the meniscus and on a ratio between the indices of refraction of the front and backside fluids. Thereby the angle of reflectance in the light path is controllable by means of said electric field.

The invention thus provides a reflective electrowetting device. This is opposed to transmissive electrowetting devices (e.g. lenses) that recently have attracted much focus. A transmissive electrowetting lens is described in, for example, WO 03/069380. In a transmissive electrowetting lens, the meniscus is typically used for deflecting light waves that are transmitted through the meniscus. In contrast, in a reflective electrowetting device in accordance with the present invention, the meniscus is used for deflecting light waves such that they are reflected. In other words, in a transmissive lenses the light waves travel through the meniscus whereas in a reflective device the light waves are reflected by the meniscus and thus remain at their original side of the meniscus.

Reflection of light that impinges the meniscus is conditioned by the front fluid having a higher index of refraction than the backside fluid, where the front fluid is the fluid through which the light is impinging the meniscus and the backside fluid resides on the other side of the meniscus. Light impinging the meniscus absolutely perpendicular will always be transmitted through the meniscus. However, depending on the magnitude of the ratio between the indices of refraction, light impinging the meniscus at a sufficient angle will be totally or partially reflected. The smaller the difference in index of refraction, the larger the angel has to be for ensuring total reflection of the light.

The general formula for deflection of light traveling across an interface between a first material having index of refraction uᵢ and a second material having index of refraction uₜ is given by

uᵢ sinθᵢ=uₜ sinθₜ (1)

where θᵢ and θₜ are the angle of incidence and the angle of exit, respectively. θ=0° corresponds to light impinging the interface perpendicularly, and θ=90° corresponds to light traveling parallel with the interface. θₜ>90° thus corresponds to total reflection of light meaning that the deflected light is reflected by the interface and thus continue traveling through the first material. Solving equation (1) for θₜ gives

θₜ=arcsine (uᵢ/uₜ sin θᵢ) (2)

Hence, provided that uᵢ>uₜ, light will be totally reflected at an angle θₜ>90° for some angle θᵢ<90°. The range of angles θᵢ that are totally reflected starts from θᵢ=90° and includes a set of smaller angles depending on the size of uᵢ/uₜ. For example, uᵢ/uₜ= 3/2results in total reflection of light that has an angle of incidence between θᵢ=90° and θᵢ=45° (since sin 45°=⅔).

In accordance with equation (2) above, the angle of the reflected light (herein denoted angle of reflectance) depends on the ratio of indices of refraction (uᵢ/uₜ) as well as on the angle of incidence (θᵢ). However, the ratio of indices of refraction is generally a static parameter (the indices of refraction of the first and second materials are essentially constant within reasonable operational circumstances). Hence, the angle of reflectance is a direct function of the angle of incidence. The angle of incidence, in turn, depends on the angle of incidence of the light waves in the reflective device as well as on the shape of the meniscus. Hence, the angle of reflectance is controllable by altering the shape of the meniscus using electrowetting forces.

In line with the present invention it is realized that this effect can be utilized for providing controllable reflective electrowetting devices. Comparing with transmissive electrowetting lenses, such a reflective electrowetting device differs in that the light path is restricted to one of the two fluids in the lens chamber, and that this particular fluid must have a higher index of refraction than the other (backside) fluid.

Even though operation of the reflective electrowetting device differs conceptually from the operation of transmissive electrowetting lenses, there are obvious similarities between the two conceptions. Hence, when it comes to materials and selection of fluids etc., teachings directed towards transmissive electrowetting lenses can be taken to apply also for reflective electrowetting lenses.

However, in a transmissive electrowetting lens the light path of the lens is typically arranged essentially perpendicular to the extension of the meniscus. In contrast, in a reflective electrowetting lens the light path of the lens is preferably arranged at an angle in respect of the meniscus. This is due to the fact that total reflection of light at the meniscus only occurs for light that impinges the meniscus as a sufficient angle.

The invention provides for a large degree of freedom regarding the shape of the meniscus. According to one embodiment, the meniscus has an essentially rectangular shape and the wetting surface is separated into two areas arranged along two facing edges of the periphery of the meniscus. Thereby the shape of the meniscus is controllable to bend only along a direction that is parallel with the wetting surface areas. An example of such an arrangement is given below with reference to FIG. 5.

According to another embodiment, the wetting surface surrounds the entire meniscus along the periphery of the fluid chamber, such that the shape of the meniscus is controllable to bend along two perpendicular directions. For example, the meniscus may be circular in shape, and the meniscus may be controllable between a convex shape and a concave shape.

According to yet one embodiment, additional electrodes are arranged along the periphery of the meniscus such that the shape of the meniscus can be controlled by different electric fields applied between different pairs of electrodes. Thereby it is possible to control the meniscus between a larger set of shapes. Furthermore, by applying suitable potentials to the respective electrode, it is possible to provide an essentially flat meniscus that is tiltable depending on the potential applied at the respective electrode.

Hence, according to yet one embodiment, the fluid chamber, the wetting surface, and the electrodes are arranged such that the shape of the meniscus is essentially flat and tiltable.

As discussed above, light must impinge the meniscus at a sufficient angle for total reflection to occur (the required angle depends on the ratio between the indices of refraction of the fluids. However, a fraction of light that impinges at a too small angle will be reflected as well, while the remaining fraction of light will be transmitted through the meniscus. In fact, the fraction of light that is reflected will increase when approaching the required angle of incidence. This phenomenon may be exploited for providing devices that are partially transmissive and partially reflective, or that reflect all light in one state but transmits most light in another state.

Hence, according one embodiment the meniscus is controllable to a shape where a first part of light traveling in the light path is reflected at the meniscus and a second part of light traveling in the light path is transmitted through the meniscus.

The reflective electrowetting device according to the present invention may also be combined into a system of reflective devices. Hence, another aspect of the present invention provides a reflective system comprising at least two reflective electrowetting devices as described above and having interconnected light paths. Thereby it is possible to provide for even more complicated light paths. For example, a first reflective electrowetting device may facilitate control along one direction and forward the light to a second reflective electrowetting device that facilitates control of the light along a second direction.

Yet one aspect of the present invention provides an array of reflective electrowetting devices. The array comprises at least two reflective electrowetting devices as described above that together form a composite light path, and each reflective electrowetting device constitutes a separately controllable sub-portion of said composite light path. Such an array may be useful in, for example, display devices where each reflective device may correspond to one picture element (pixel).

Yet one aspect of the present invention provides for the use of a reflective electrowetting device as described above for reflecting light waves that impinges said meniscus in a direction that depends on a shape of the meniscus.

### BRIEF DESCRIPTION OF THE FIGURES

The present invention will now be further described with reference to the accompanying, exemplifying drawings, on which:

FIG. 1 illustrates cross-sections of a reflective electrowetting device where the meniscus is in a first state (left) and a second state (right), respectively, and where the light path is arranged through sidewalls of the fluid chamber.

FIG. 2 illustrates a cross-section of an electrowetting device where the light path is arranged through a top surface of the fluid chamber.

FIG. 3 illustrates a perspective view of an array of reflective electrowetting devices, where each device provides for a separately controllable sub-portion of a composite light path.

FIG. 4 illustrates a cross-section (left) and a top view (right) of a circular reflective electrowetting device having a number of electrodes arranged along the periphery of the meniscus.

FIG. 5 illustrates a perspective view of a rectangular reflective electrowetting device where the meniscus is controllable to bend essentially along one direction only.

FIG. 6 illustrates a system of two reflective electrowetting devices having interconnected light pats.

### DETAILED DESCRIPTION OF THE INVENTION

For reasons of clarity, the basic mechanisms behind an electrowetting device will first be described. The general idea is to use a combination of two forces, namely lyophobic forces and electrostatic forces.

Lyophobic forces are the forces exercised on a solvent by a solvent-repellant surface. For water-based solvents, the mechanism is normally called hydrophobic. For example, a waxed surface is typically water-repellant and hence hydrophobic.

Electrostatic forces are the forces exercised by electrical charges that are attracted or repelled from each other.

The general idea in electrowetting devices is to create a fluid system consisting of two immiscible fluids that have different electrostatic properties and that behave differently in respect of a lyophobic surface. In a basic configuration, the device comprises a fluid chamber that contains the fluid system and that has lyophobic portions arranged at its inner surface. The lyophobic portions are arranges so that the fluid system has one distinct resting position, and hence a distinct shape of the meniscus separating the fluids. The fluids may be oil and water, for example, and the lyophobic portions are then preferably hydrophobic. For example, half the inner surfaces of the fluid chamber may be hydrophobic and the remaining inner surfaces may be neutral in respect of the two fluids. Thereby the water will reside in the neutral portion of the chamber and the oil will reside in the hydrophobic portion of the chamber.

The different electrostatic properties of the fluids are such that one of the fluids is electrically conductive, and hence attracted by electric fields, and the other fluid is electrically non-conductive (or, at least, substantially less conductive), and hence not affected by electric fields.

In addition to the lyphobic surface portions, there are electrodes arranged in the chamber. The electrodes are arranged to apply a potential across the fluid that is electrically conductive. Application of such a field will attract the electrically conductive fluid towards the electrodes, thus creating an additional force in the fluid system that will alter the positions of the fluid hand hence the shape of the meniscus. Thereby it is possible to move the fluids and to alter the shape of the meniscus simply by applying an electrical field and without the use of any moving parts.

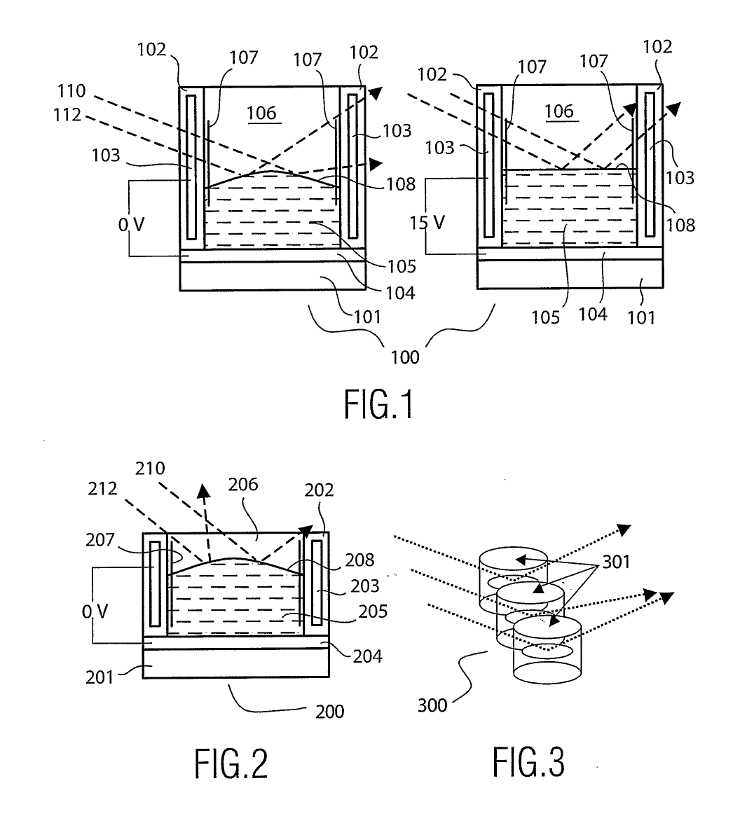

FIG. 1 illustrates schematic cross-sections of an embodiment of a reflective electrowetting device 100 in accordance with the present invention. The reflective electrowetting device 100 comprises a cylindrical fluid chamber that contains two immiscible fluids, a front side fluid 106 and a backside fluid 105. The fluid chamber has a cylindrical wall 102, an upper sidewall 111 and a lower sidewall 101. The cylindrical wall carries a cylindrical electrode 103 and a wetting surface 107 around its periphery. The wetting surface 107 faces the interior of the cylinder and has different wetting properties in respect of the two immiscible fluids 105, 106.

The front side fluid 106 and the backside fluid 105 are separated by a meniscus 108. The front side fluid 106 has an index of refraction that is higher than the index of refraction of the backside fluid 105. Furthermore, one of the immiscible fluids is electrically conducting whereas the other fluid is essentially non-conductive. In addition, the immiscible fluids have different wetting properties in relation to the wetting surface 107. The two immiscible fluids may, for example, be formed of silicon oil and saline water (water with dissolved NaCl). Depending on the particular silicone oil selected and on the salinity of the water, the fluid having the highest index of refraction should be the front fluid.

The arrangement of the two immiscible fluids and the fluid chamber can be designed much like arrangements known from transmissive electrowetting lenses.

The left-hand cross-section illustrated in FIG. 1 depicts a reflective electrowetting device having a convex shape of the meniscus 108 that separates the two fluids. Depending on their point of incidence on the meniscus, light rays are scattered between relatively big and relatively small angles of reflectance. The dashed arrow 110 in the figure illustrates one particular light ray that is reflected a relatively small angle since it impinges the meniscus almost perpendicular, and the dashed arrow 111 illustrates a light ray incoming in parallel that is reflected at a much steeper angle since it impinges the meniscus at a different position.

The reflective electrowetting device illustrated in FIG. 1 defines a light path that crosses the cylinder wall 102, the cylindrical electrode 103, and the wetting surface 107. This design thus requires these components to be of optical quality (i.e. to be transparent during the lifetime of the device). This may be disadvantageous for some applications.

FIG. 2 illustrates an alternative reflective electrowetting device where the light path is instead directed through the top wall 111. Thereby only the top wall 111 needs to be of optical quality, and the sidewalls ca be manufactured from any material irrespective of optical properties. In FIG. 2, the same features and components are disclosed as in FIG. 1, having reference numbers incremented with 100 (i.e. 101 being denoted 201 etc.).

Obviously, it is also possible to arrange for the light path to travel through portions of the top wall 111 as well as though portions of the cylindrical wall 102.

Using devices as illustrated in FIG. 2, having their light path directed through the top wall only makes it easy to arrange arrays of independently controllable reflectors, as illustrated in FIG. 3 where three separate reflectors 301 are arranged in an reflector array 300.

As observed above, total reflection is achieved for light impinging the meniscus within certain angles, depending on the ratio between the indices of refraction of the front and backside fluids. Since this ratio can not be infinite, there will always be a range of angles centered around 0° (perpendicular to the meniscus) where total reflection is not achieved. The smaller the ratio between the indices of refraction, the larger this set of angles will be (hence requiring the incident light to impinge the meniscus at an angle more parallel to the meniscus).

However, light impinging the meniscus at a too small angle of incidence for total reflection to occur is typically anyway reflected to some degree. Hence, it is possible to control the angle of reflectance even outside the range that provides for total reflection, bearing in mind that only a fraction of the light will be reflected. Depending on the optical characteristics of the backside fluid, the reminder of the light will either be transmitted through or absorbed in the backside fluid.

Partial reflection can be utilized in applications where it is desirable to reflect some light and to transmit some light. In such applications, the transmitted light is typically deflected by the meniscus as in an ordinary, transmissive electrowetting lens.

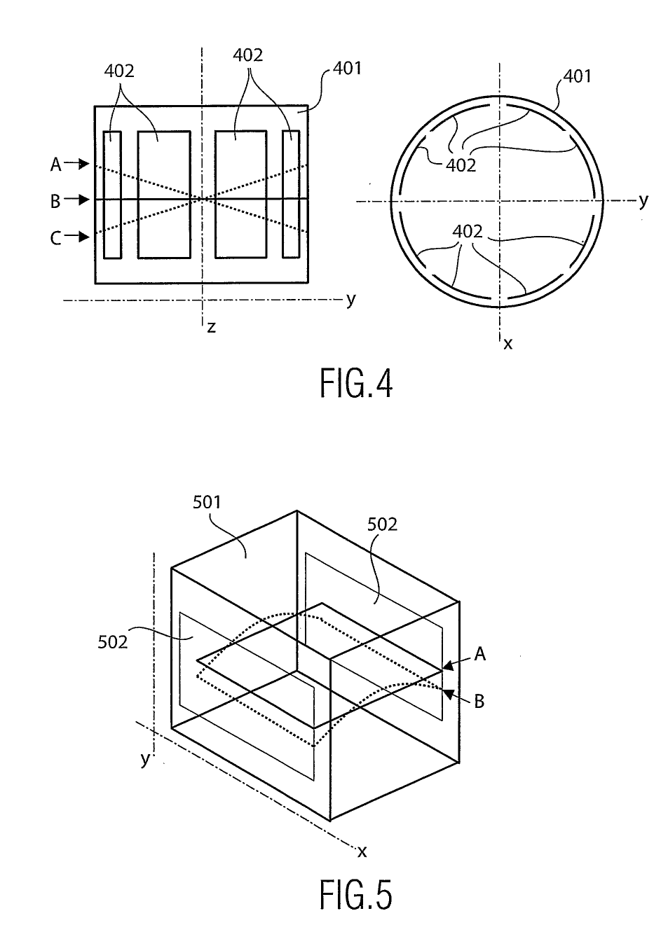

Arranging the fluid chamber, the wetting surfaces and the electrode in a suitable manner provides for a large space of different meniscus shapes. FIG. 4 illustrates a top view (right) and a side view (left) of an embodiment where this fact is utilized. As illustrated in FIG. 4, a cylindrical fluid chamber 401 may be fitted with a number of periphery electrodes 402. Thereby it is possible to alter the shape of the meniscus with a large degree of freedom. For example, the meniscus may be tilted in an arbitrary angle while maintaining the flatness of the surface almost unaffected. Thereby it is possible to reflect a light beam in an arbitrary direction in relation to the x- and y-directions without scattering the light. In FIG. 4, three different meniscus settings are illustrated (A, B, and C).

Yet one alternative meniscus shape is illustrated in FIG. 5, where the fluid chamber 501 is rectangular with wetting surfaces 502 are arranged only at two, opposite sidewalls. Thereby it is possible to arrange for the meniscus to bend along an axis that is parallel with the wetting surfaces (the x-axis in FIG. 5). In FIG. 5, two different meniscus states are illustrated (A and B). This thus facilitates the manipulation of light that falls onto the device in a line-form rather than a point. In effect, incoming light can be scattered in one direction (the y-direction in FIG. 5) but remains unaffected in the other direction (the x-direction in FIG. 5).

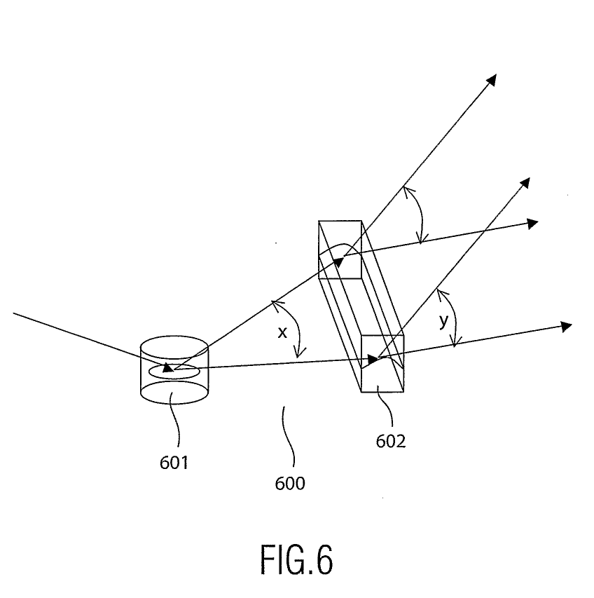

Furthermore, referring to FIG. 6 it is possible to arrange a system of interrelated reflective devices. In FIG. 6, two reflective devices are arranged, a first reflector 601 that is arranged to manipulate the light in a first direction (here the x-direction) and a second reflector 602 that is arranged to manipulate the light in a second direction (here the y-direction). The first reflector 601 may be of the type illustrated in FIG. 1 or 2, and the second reflector 602 may be of the type illustrated in FIG. 5. Thereby it is possible to achieve accurate manipulation in two dimensions using less complex components. Two-dimensional manipulation is, of course, possible using a reflector as illustrated in FIG. 3. However, arrangements as illustrated in FIG. 3 are more complicated to manufacture than those having only two electrodes. (Two electrodes are sufficient for arrangements as illustrated in FIGS. 1, 2, and 4.)

The reflective electrowetting device may be used in a large number of applications. For example, many applications that conventionally use rotating mirrors may benefit from the advantages provided by the present invention. The reflective electrowetting device may, for example, be used in (bar-code) scanners, displays (projection devices), communication devices and lighting devices.

In summary, the present invention provides a reflective electrowetting device 200 comprising a fluid chamber that contains two immiscible fluids 205, 206 that are separated by a meniscus 208. The fluid chamber further comprises electrodes 203, 204, and a wetting surface 207 that has different wetting properties in respect of the two immiscible fluids 205, 206. Electrowetting forces, provided by the interaction of lyophobic and electrostatic forces, are utilized to control the meniscus 208) such that light 210, 212 impinging the meniscus is reflected by total reflection at the meniscus. The present invention furthermore provides a system and an array of such reflective electrowetting devices.

1. Reflective electrowetting device (100; 200) defining a light path for light waves (110, 112; 210, 212) and comprising a fluid chamber, at least two electrodes (103, 104; 203, 204), a wetting surface (107; 207), and an electrowetting fluid system contained in said fluid chamber and comprising a front fluid (106; 206) and a backside fluid (105; 205), said front fluid (106; 206) and backside fluid (105; 205) having different electrical properties, different wetting properties in respect of the wetting surface (107; 207), and being separated by a meniscus (108; 208) having a shape that is controllable by an electric field applied across said electrodes (103, 104; 203, 204), said front fluid (106; 206) forming part of said light path and having an index of refraction that is higher than that of said backside fluid (105; 205) such that total reflection is provided in the light path by the meniscus (108; 208) at an angle of reflectance that depends on the shape of the meniscus (108; 208) and on a ratio between the indices of refraction of the front and backside fluids (106, 105; 206, 205), whereby the angle of reflectance in the light path is controllable by means of said electric field.

2. Reflective electrowetting device according to claim 1, wherein the meniscus has an essentially rectangular shape and the wetting surface (502) is separated into two areas arranged along two facing edges of the periphery of the meniscus, such that the shape of the meniscus is controllable to bend (A, B) along a direction that is parallel with the wetting surface areas only.

3. Reflective electrowetting device (100; 200) according to claim 1, wherein the wetting surface (107; 207) surround the entire meniscus (108; 208) along the periphery of the fluid chamber, such that the shape of the meniscus (108; 208) is controllable to bend along two perpendicular directions.

4. Reflective electrowetting device according to claim 1, comprising additional electrodes (402) arranged along the periphery of the meniscus such that the shape of the meniscus can be controlled by different electric fields applied between different pairs of electrodes.

5. Reflective electrowetting device according to claim 1, wherein the fluid chamber (401), the wetting surface, and the electrodes (402) are arranged such that the shape of the meniscus is essentially flat and tiltable (A, B, C).

6. Reflective electrowetting device (100; 200) according to claim 1, wherein the meniscus (108; 208) is controllable to a shape where a first part of light traveling in the light path is reflected at the meniscus and a second part of light traveling in the light path is transmitted through the meniscus.

7. Reflective system (60) comprising at least two reflective electrowetting devices (601, 602) as defined in claim 1 and having interconnected light paths.

8. Array of reflective electrowetting devices (300), comprising at least two reflective electrowetting devices (310) as defined in claim 1 and together forming a composite light path, wherein each electrowetting reflective device constitute a separately controllable sub-portion of said composite light path.

9. Use of a reflective electrowetting device as defined in claim 1, for reflecting light waves that impinges said meniscus in a direction that depends on a shape of the meniscus.
